(19) United States
(12) Patent Application Publication
(10) Pub. No.: US 2002/0186394 A1
(43) Pub. Date: Dec. 12, 2002

(54) Contents supply system and server used for this

(75) Inventors: Tadashi Shiozaki, Nagano-ken (JP); Satoshi Iinuma, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/124,483

(22) Filed: Apr. 18, 2002

(30) Foreign Application Priority Data
Jun. 8, 2001 (JP) 2001-173779
Apr. 16, 2002 (JP) 2002-113527

(51) Int. Cl. G06F 15/00; G06K 1/00; B41F 1/00; B41J 1/00; B41B 1/00

(52) U.S. Cl. 358/1.13

(57) ABSTRACT

The user selects a desired image in an image selection page, and enters output conditions of the desired image, for example, the paper species, the print size, and the ink specifies, in an output conditions entry page. In an image supply method selection page, the user subsequently selects a desired image supply method between a distribution supply method, which distributes image data satisfying the image output conditions to a computer of a user via the Internet, and a delivery supply method, which delivers a print of the image printed according to the image output conditions with a printer in a print center. The user can thus immediately print the selected image with the own printer or alternatively receive delivery of a resulting print of the image printed according to the output conditions, which are not applicable to the printer.

### BACKGROUND OF THE INVENTION

1. Field of the Invention

The present invention relates to a contents supply system and a server used therefor. More specifically the invention pertains to a contents supply system that is capable of supplying contents to users via a network, as well as a server used for this system.

2. Description of the Prior Art

A diversity of contents supply systems have been proposed to distribute contents, such as image data, sound data, character data, and computer software, via a network in response to selection of each user. Any of these content supply systems can directly supply the user's selected content to the user at a user's desired timing.

In the conventional content supply system, however, it is possible that the user can not sufficiently utilize the supplied content. This problem occurs, f or example, when the user desires to print the image data supplied as the content. The size of a resulting print and the printing quality depend upon the performances of a printer owned by the user. Namely the user cannot receive the print better than the performances of the own printer. A similar problem arises when the user receives supply of music data as the content and desires to play out the music data with audio equipment. When the user does not possess a device or software for converting the supplied music data into a format playable with the audio equipment, the music data can not be played out with the audio equipment.

### SUMMARY OF THE INVENTION

The object of the present invention is thus to allow supply of a selected content to each user according to a plurality of different supply methods. The object of the invention is also to supply a selected content in a specific way that allows the user to use the content in a desired form.

In order to achieve at least a part of the aforementioned objects, the present invention is structured as follows.

A first contents supply system of the present invention is a contents supply system that supplies contents to users via a network, the contents supply system including:

a content selection module that selects a content in response to a choice of each user;

a supply method setting module that selects and specifies a content supply method among at least two different content supply methods, in response to a choice of the user; and

a content supply instruction module that supplies the selected content to the user or gives an instruction for the supply according to the specified supply method.

The first contents supply system of the present invention enables the user to select a desired content supply method. This ensures selection of the desired form of the content according to the selected content supply method.

In the first contents supply system of the present invention, the supply method setting module can select and specify a content supply method among a plurality of available supply methods including a distribution supply method, which distributes the selected content via the network, and a delivery supply method, which delivers a content processed matter obtained by processing of the selected content. This arrangement gives the form of the content distributable via the network and the form of the content as a content processed matter as available options and enables the user to receive the supply of the content in the desired form. In this case, the content supply instruction module can distribute the selected content to the user via the network in response to selection of the distribution supply method by the supply method setting module, while transmitting information regarding delivery to the user and information regarding the processing of the selected content as the supply instruction in response to selection of the delivery supply method by the supply method setting module. In one preferable application, the content is digital data, such as image data, sound data, character data, or computer software, and the content processed matter is a content storage medium in which the content is stored according to a preset format. In another preferable application, the content is either of image data and character data, and the content processed matter is a printed matter obtained by printing the content.

A server of the present invention is a server for a contents supply site that is capable of supplying contents to users via a network, the server including: a content selection page providing module that provides a content selection page to allow each user to select a desired content; and a supply method selection page providing module that provides a supply method selection page to allow the user to select a desired supply method for the content selected in the content selection page.

The server of the present invention enables the user to select a desired content supply method. This ensures selection of the desired form of the content according to the selected content supply method.

As one aspect, the server of the present invention structured in this way can include a supply method check page providing module that provides a supply method check page to check supply of the selected content to the user according to the supply method selected in the supply method selection page. This arrangement enables the user to check the selected content supply method.

As another aspect, in the server of the present invention, the supply method selection page can show, as available options, multiple supply methods including a distribution supply method, which distributes the selected content via the network, and a delivery supply method, which delivers a content processed matter obtained by processing the selected content. In one preferable application, the content is digital data, such as image data, sound data, character data, or computer software, and the content processed matter is a content storage medium in which the content is stored according to a preset format. In another preferable application, the content is either of image data and character data, and the content processed matter is a printed matter obtained by printing the content.

A second contents supply system of the present invention is a contents supply system including a reception server that accepts requests of supply of contents to users via a network and at least one processing machine corresponding to each content type communicably connected to the reception server,

wherein the reception server includes: a reception module that accepts each request of supply with a user's selection of a desired content and a desired supply method of the selected content; and a supply request transfer module that transfers the accepted request of supply to a processing machine corresponding to a content type involved in the request of supply, according to the selected supply method involved in the request of supply,

the processing machine including: a processing module that makes the content, which is involved in the request of supply transferred by the supply request transfer module, subjected to processing corresponding to the selected supply method involved in the request of supply; and an instruction output module that gives an instruction to attain delivery of a content processed matter, which is obtained by processing the selected content, to the user involved in the request of supply.

The second contents supply system of the present invention accepts a request of supply of a content with entry of selection by each user, and transfers the request of supply to a processing machine corresponding to a content type involved in the accepted request of supply. The processing machine makes the content subjected to processing corresponding to a selected content supply method, and gives an instruction to supply a resulting content processed matter to the user. This arrangement thus enables a desired content to be processed and supplied according to the user's selected content supply method. In one preferable application, the content is any of image data, sound data, character data, or computer software, and the content processed matter is a content storage medium in which the content is stored according to a preset format. In another preferable application, the content is either of image data and character data, and the content processed matter is a printed matter obtained by printing the content. In addition, the processing machine may be connected to the reception server via the network.

As one aspect, in the second contents supply system of the present invention structured in this way, the processing machine can include a processing information transmission module that transmits processing information regarding available processing by the processing module to the reception server, and

the reception module of the reception server can display available supply methods to allow selection of the user, based on the processing information transmitted by the processing information transmission module.

As another aspect, in the second contents supply systems of the present invention, the available supply methods can include a distribution supply method, which distributes the selected content via the network, and a delivery supply method, which delivers a content processed matter, and

the reception server can distribute the content involved in the request of supply to the user involved in the request of supply via the network, when the supply method involved in the request of supply is the distribution supply method. In the case of selection of the distribution supply method, the content is distributed to the user via the network. In the case of selection of the delivery supply method, on the other hand, the content processed with the processing machine is delivered to the user.

A reception server of the present invention is a reception server that accepts requests of supply of contents to users via a network in a contents supply system including the reception server and at least one processing machine corresponding to each content type communicably connected to the reception server, the reception server including:

a reception module that accepts each request of supply of a content to a user with the user's selection of a desired content and a desired supply method of the selected content; and

a supply request transfer module that transfers the accepted request of supply to a processing machine corresponding to a content type involved in the request of supply, according to the selected supply method involved in the request of supply.

The reception server of the present invention accepts a request of supply of a content with entry of selection by each user, and transfers the request of supply to a processing machine corresponding to a content type involved in the accepted request of supply. The user can thus receive the content processed with the processing machine according to the user's selected content supply method.

In the reception server of the present invention structured in this way, the reception module can display a supply method corresponding to available processing by the processing machine to allow selection of the user, and can receive the request of supply from the user.

### BRIEF DESCRIPTION OF THE DRAWINGS

FIG. 1 schematically illustrates the construction of a system including an image supply server 32 in a first embodiment of the present invention;

FIG. 2 is a flowchart showing an image supply routine executed by the image supply server 32;

FIG. 3 shows an example of image selection page;

FIG. 4 shows an example of an input dialog box for a print size in an output conditions entry page;

FIG. 5 shows an example of image supply method selection page;

FIG. 6 is a flowchart showing another image supply routine executed in a modified example:

FIG. 7 schematically illustrates the construction of a system including a contents supply system 130 in a second embodiment of the present invention;

FIG. 8 is a flowchart showing a content acceptance routine executed by a reception server 132;

FIG. 9 shows an example of content type selection page;

FIG. 10 shows an example of content supply method selection page; and

FIG. 11 is a flowchart showing a registration routine executed by a processing server.

### DESCRIPTION OF THE PREFERRED EMBODIMENTS

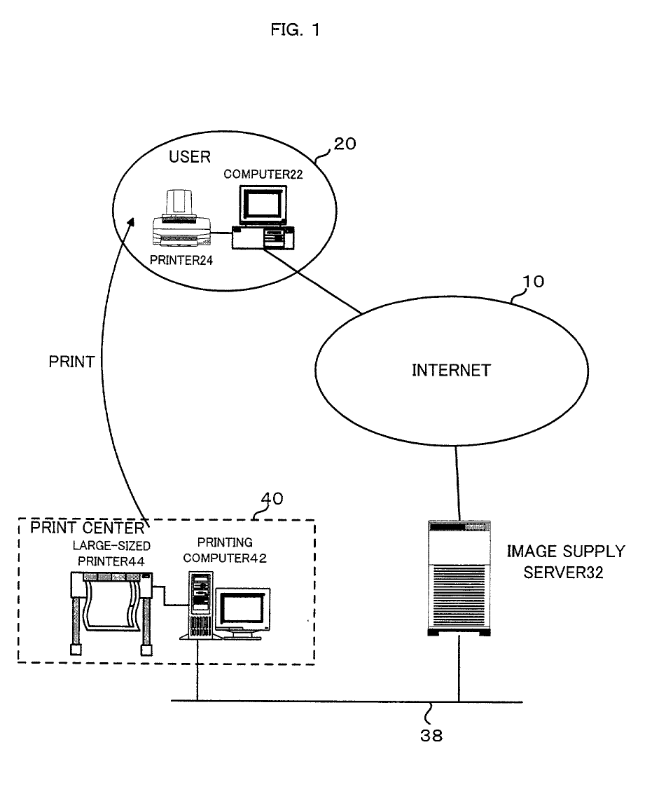

The following describes preferred embodiments of the present invention. FIG. 1 schematically illustrates the construction of a system including an image supply server 32 in a first embodiment of the present invention. As illustrated, the image supply server 32 of the first embodiment is a Web server functioning as an image supply site, which can distribute still images (image data) as contents to a computer 22 of a user 20 via the Internet 10 in response to a requirement of the user 20. The image supply server 32 is connected to a printing computer 42 in a print center 40 via a network 38 different from the Internet 10.

The image supply server 32 stores a large number of image data with IDs assigned thereto in a non-illustrated external storage device, such as a hard disk, and provides the image supply site to supply images via the Internet 10 to the user 20 who has signed up and registered with input of personal information including the name, the postal address, and the E-mail address. In response to a selection of the user 20, the image supply site distributes image data of a selected and size-adjusted image together with a control signal for printing to the computer 22 of the user 20 via the Internet 10. The image supply site alternatively transmits an ID assigned to the selected image, image output conditions, and delivery information including a destination of delivery to the user 20, to the printing computer 42 in the print center 40 via the network 38.

The computer 22 of the user 20 is connected to a conventional printer 24 for color printing up to a size A4 or a size B4. An image is accordingly printed, based on the image data and the control signal for printing distributed from the image supply server 32 of the first embodiment.

The printing computer 42 in the print center 40 stores image data, which are identical with the large number of image data stored in the image supply server 32, with their IDs in a non-illustrated external storage device, such as a hard disk. The printing computer 42 processes the stored image data according to the ID of the image and the image output conditions transmitted from the image supply server 32, and causes the processed image to be printed with a large-sized printer 44 for color printing up to a size AO or a size BO connected with the printing computer 42. A resulting print of the image is delivered to the user 20, based on the delivery information of the user 20 transmitted from the image supply server 32.

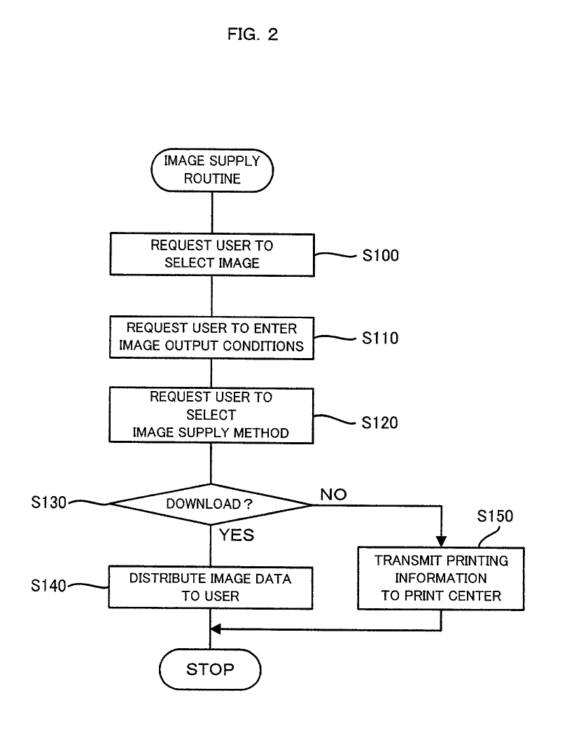

The following describes an image supply process executed at the image supply site provided by the image supply server 32 of the first embodiment. FIG. 2 is a flowchart showing an image supply routine executed by the image supply server 32. This image supply process is carried out after the computer 22 of the user 20 logs on the image supply site provided by the image supply server 32 via the Internet 10. The user 20 should input an ID and a password given at the time of sign-up and registration for log-in to the image supply site.

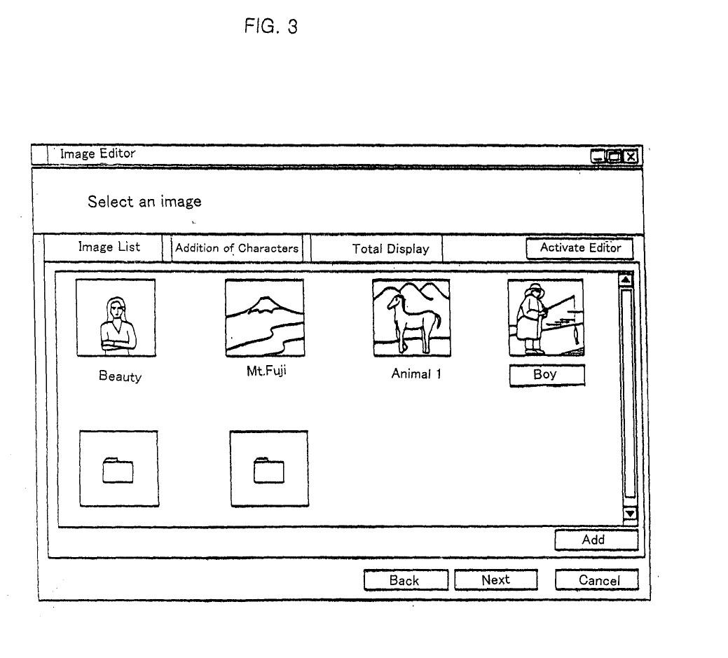

When the program enters the image supply routine, the user 20 is first required to select a desired image (step S100). Selection of the desired image is carried out on an image selection page displaying multiple thumbnails. The user 20 specifies any of the displayed thumbnails with a pointing device for selection of the image. One example of the image selection page is shown in FIG. 3.

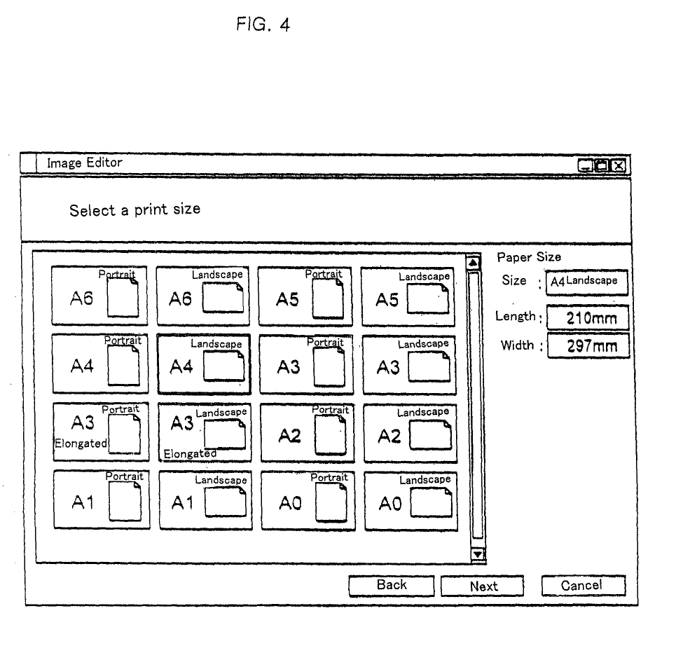

On completion of selection of the desired image by the user 20, the program opens an output conditions entry page and requests the user to enter the image output conditions (step S110). The image output conditions entered here include an output object, such as a paper species, a print size, and an ink species. An input dialog box for the print size in the output conditions entry page is shown in FIG. 4.

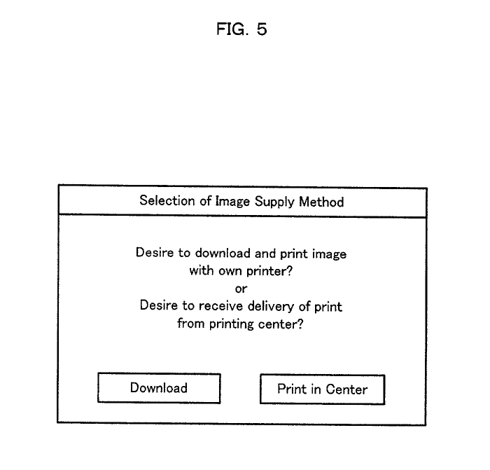

After entry of the image output conditions, the program opens an image supply method selection page and requests the user to select a desired image supply method (step S120). In the first embodiment, options of the image supply method include a distribution supply method that distributes image data satisfying the image output conditions from the image supply server 32 to the computer 22 of the user via the Internet 10, and a delivery supply method that delivers a printed matter obtained by printing the image based on the image output conditions with the large-sized printer 44 in the print center 40. One example of the image supply method selection page is shown in Fig. 5. In the image supply method selection page of FIG. 5, the user 20 may click a ‘Download’ button to select the distribution supply method or alternatively click a ‘Print in Center’ button to select the delivery supply method.

In the case of selection of the distribution supply method as the image supply method, that is, in response to a click of the ‘Download’ button in the example of FIG. 5, the image supply server 32 distributes the image data satisfying the image output conditions entered in the output conditions entry page to the computer 22 of the user 20 via the Internet 10 (step S140). In the case of selection of the delivery supply method, that is, in response to a click of the ‘Print in Center’ button in the example of FIG. 5, on the other hand, the image supply server 32 transmits the ID assigned to the image selected in the image selection page, the image output conditions entered in the output conditions entry page, and the personal information of the user 20 to the printing computer 42 in the print center 40 via the network 38 (step S150). The program then exits from this image supply routine.

The computer 22 of the user 20 receives the distributed image data and causes the image data to be printed according to the entry of the image output conditions with the printer 24 connecting with the computer 22. The operation of printing the image with the printer 24 is controlled by the control signal for printing, which has been distributed together with the image data from the image supply server 32 to the computer 22. The number of prints is also under control.

The printing computer 42 in the print center 40 receives the ID of the image, the image output conditions, and the personal information of the user 20, and causes an image specified by the ID to be processed according to the image output conditions and printed with the large-sized printer 44. A resulting print of the image is then delivered to the user 20, based on the personal information of the user 20.

The image supply site provided by the image supply server 32 of the first embodiment enables the user 20 to select the desired image supply method between the method of distributing the selected image and causing the image to be printed with the printer 24 of the user 20 and the method of causing the selected image to be printed with the large-sized printer 44 in the print center 40 and delivering a resulting print. The user 20 can thus immediately print the selected image with the own printer 24 or alternatively receive delivery of a resulting print of the image printed according to the output conditions, which are not applicable to the printer 24 because of the restricted performances of the printer 24.

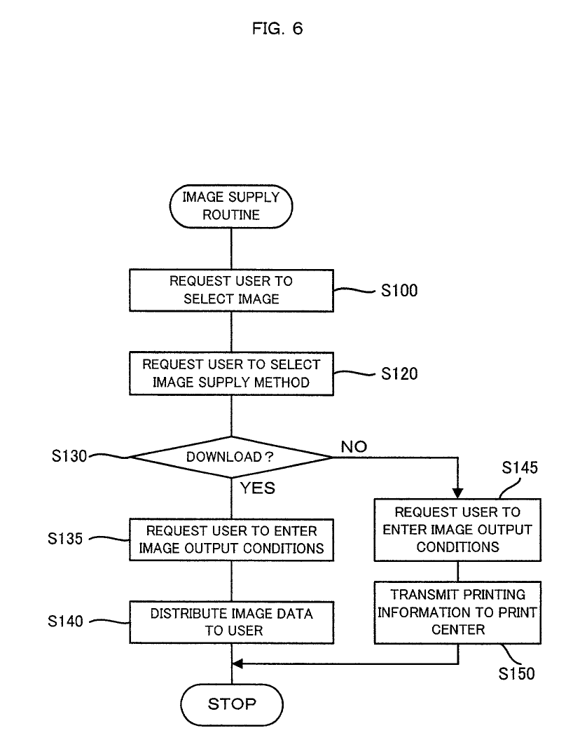

In the image supply site provided by the image supply server 32 of the first embodiment, the image supply method is selected in the image supply method selection page after entry of the image output conditions in the output conditions entry page. As shown in a modified image supply routine of FIG. 6, the image output conditions may be entered in the output conditions entry page after selection of the image supply method in the image supply method selection page (steps S135 and S145). This procedure allows different settings for the entry page of the image output conditions according to the distribution supply method and for the entry page of the image output conditions according to the delivery supply method. Namely this modified application enables detailed entry of the image output conditions.

In the construction of the first embodiment, the image supply server 32 is connected to the printing computer 42 in the print center 40 via the network 38. The image is printed in the print center 40 in the case of selection of the delivery supply method. In one possible modification, the large-sized printer 44 is connected to the image supply server 32. The image supply server 32 may directly print the image with the large-sized printer 44 and deliver the resulting print. In another possible modification, there are multiple print centers 40. The image may be printed in and delivered from any of these print centers 40.

In the procedure of the first embodiment, a desired image supply method is selectable between the two options, that is, the distribution supply method that distributes the image data and the delivery supply method that delivers a resulting print of the image. One possible modification allows selection of one image supply method among three or more options. Another possible modification allows selection of multiple image supply methods.

In the construction of the first embodiment, the image supply server 32 is constructed by one computer, although the image supply server 32 may be constructed by a plurality of computers.

The image supply server 32 of the first embodiment provides the image supply site that is capable of distributing still images as contents to the user 20 via the Internet 10. The contents are not restricted to the still images, but a motion picture supply site, a sound supply site, a character information supply site, or a software supply site may be provided to supply motion pictures, sound, characters, or computer software. In the case of selection of the distribution supply method, the motion picture supply site may distribute motion picture data processed by, for example, MPEG2 and allow the distributed motion picture data to be played out with the computer 22. In the case of selection of the delivery supply method, on the other hand, the motion picture supply site may store the motion picture data in a portable storage medium, such as a DVD-ROM, and deliver the portable storage medium. In the case of selection of the distribution supply method, a music supply site, an example of the sound supply site, may distribute music data processed by, for example, MP3 and allow the distributed music data to be played out with the computer 22. In the case of selection of the delivery supply method, the music supply site may store the MP3-based music data into a music CD according to a converted format and deliver the music CD. In the case of selection of the distribution supply method, an electronic book distribution site, an example of the character information supply site, may distribute character letter (sentence data) processed according to a preset format and allow the character data to be displayed on the computer 22. In the case of selection of the delivery supply method, the electronic book distribution site may deliver the character data in the form of an electronic book stored in a CD-ROM or in the form of a bound book with the printed character data. In the case of selection of the distribution supply method, the software supply site may distribute a software program processed according to a preset format and allow the software program to be installed in the computer 22. In the case of selection of the delivery supply method, the software supply site may store the software program in a CD-ROM and deliver the CD-ROM.

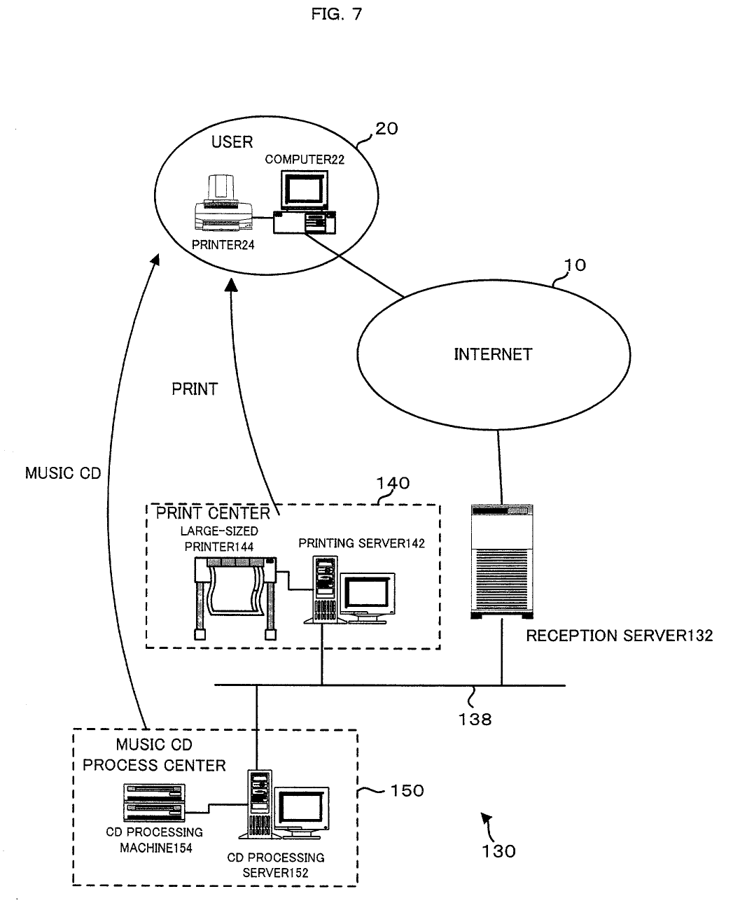

A second embodiment of the present invention is discussed below. FIG. 7 schematically illustrates the construction of a system including a contents supply system 130 in the second embodiment of the present invention. The contents supply system 130 of the second embodiment includes a reception server 132 functioning as a contents supply site, which can distribute contents to the computer 22 of the user 20 via the Internet 10 in response to a requirement of the user 20, a printing server 142 in a print center 140 connected to the reception server 132 via a network 138, and a CD processing server 152 in a music CD process center 150 connected to the reception server 132 via the network 138. The reception server 132 is also connected to servers in various centers for processing diverse contents other than the printing server 142 and the CD processing server 152, for example, a DVD processing server in a movie DVD process center and a book processing server in a book process center, via the network 138, although these centers and servers are omitted from the illustration as a matter of convenience.

The reception server 132 stores image data, music data, motion picture data like movies, character data like books as a large number of contents with IDs assigned thereto in a non-illustrated external storage device, such as a hard disk. The reception server 132 provides a contents supply site that supplies contents via the Internet 10 to the user 20 who has signed up and registered with input of personal information including the name, the postal address, and the electronic mail address. In response to a selection of the user 20, the contents supply site distributes corresponding content data and a control signal based on output conditions of the selected content via the Internet 10 to the computer 22 of the user 20. The contents supply site alternatively transmits an ID assigned to the selected content, output conditions of the content, and delivery information including a destination of delivery to the user 20 via the network 138 to a processing server corresponding to the type of the selected content, for example, the printing server 142 in the print center 140 or the CD processing server 152 in the music CD process center 150.

The conventional printer 24 for color printing up to the size A4 or the size B4 and other non-illustrated peripheral devices are connected to the computer 22 of the user 20. The computer 22 enables the content data distributed from the reception server 32 to be output from the printer 24 or a corresponding peripheral device in response to the control signal.

The printing server 142 in the print center 140 functions in a similar manner to the printing computer 42 of the first embodiment, and stores image data, which are identical with the image data among the large number of contents stored in the reception server 132, with their IDs in a non-illustrated external storage device, such as a hard disk. The printing server 142 processes the stored image data according to the ID and the output conditions of the content transmitted from the reception server 132, and causes the processed image to be printed with a large-sized printer 144 for color printing up to a size AO or a size BO connected with the printing server 142. A resulting print of the image is delivered to the user 20, based on the delivery information of the user 20 transmitted from the reception server 132.

The CD processing server 152 in the music CD process center 150 stores music data, which are identical with the music data among the large number of contents stored in the reception server 132, with their IDs in anon-illustrated external storage device, such as a hard disk. The CD processing server 152 processes the stored music data according to the ID and the output conditions of the content transmitted from the reception server 132, and records the processed music data into a CD with a CD processing machine 154 connected with the CD processing server 152 to prepare a music CD. The prepared music CD is delivered to the user 20, based on the delivery information of the user 20 transmitted from the reception server 132.

The non-illustrated servers in various centers for processing diverse contents for example, the DVD processing server in the movie DVD process center and the book processing server in the book process center function in a similar manner to the printing server 142 and the CD processing server 152, although the type of the content and the output conditions differ. Content processed matters are prepared with corresponding content processing machines connected to the respective servers. The resulting content processed matters are delivered from the respective centers to the user 20.

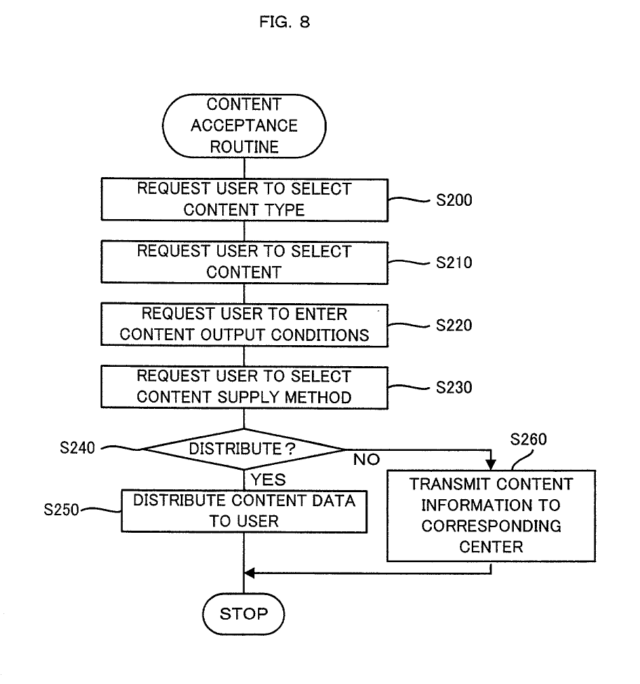

The following describes a content acceptance process executed at the contents supply site provided by the reception server 132 in the contents supply system 130 of the second embodiment. FIG. 8 is a flowchart showing a content acceptance routine executed by the reception server 132. This content acceptance process is carried out after the computer 22 of the user 20 logs on the contents supply site provided by the reception server 132 via the Internet 10. The user 20 should input an ID and a password given at the time of sign-up and registration for log-in to the contents supply site. The following discussion regards an example of supplying a still image to the user 20 as a content.

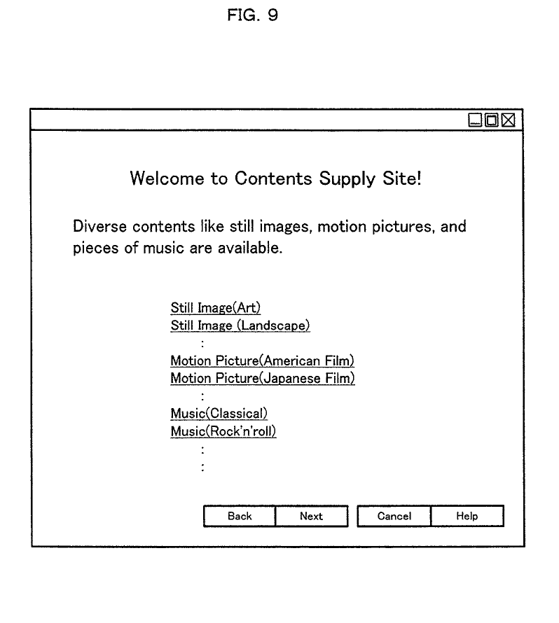

When the program enters the content acceptance routine, the user 20 is first required to select a desired content type (step S200). Selection of the desired content type is carried out on a content type selection page output from the reception server 132 and displayed on the computer 22. FIG. 9 shows an example of the content type selection page. After selection of the content type, the user 20 is required to select a desired content (step S210). Selection of the desired content is carried out on a content selection page displaying multiple contents as options. One example of the content selection page opened in response to selection of the still image as the desired content type is identical with FIG. 3 of the first embodiment.

On completion of selection of the desired content by the user 20, the program opens an output conditions entry page and requests the user to enter the content output conditions (step S220). In the case where the selected content is a still image, output conditions of still image data include an output object, such as a paper species, a print size, and an ink species. An input dialog box for the print size in the output conditions entry page in the case of the still image content is identical with FIG. 4 of the first embodiment. In the case where the selected content is a piece of music, output conditions of music data include a data format like MP3 data and an output object, such as a music CD or a flash memory.

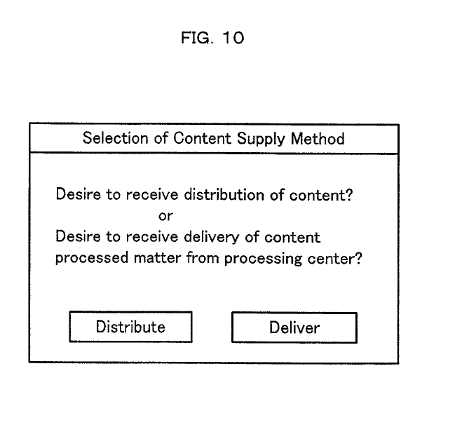

After entry of the content output conditions, the program opens a content supply method selection page and requests the user to select a desired content supply method (step S230). Options of the content supply method include a distribution supply method that distributes content data satisfying the content output conditions from the reception server 132 to the computer 22 of the user 20 via the Internet 10, and a delivery supply method that delivers a content processed matter obtained by processing the content based on the content output conditions with the corresponding processing machine in each center. In the example of the still image content, the distribution supply method distributes image data satisfying the output conditions of the still image from the reception server 132 to the computer 22 of the user 20 via the Internet 10. The delivery supply method delivers a printed matter obtained by printing the still image based on the output conditions of the still image with the large-sized printer 144 in the print center 140. One example of the content supply method selection page is shown in FIG. 10. In the content supply method selection page of FIG. 10, the user 20 may click a ‘Distribute’ button to select the distribution supply method or alternatively click a ‘Deliver’ button to select the delivery supply method.

In the case of selection of the distribution supply method as the content supply method, that is, in response to a click of the ‘Distribute’ button in the example of FIG. 10, the reception server 132 distributes the content data satisfying the content output conditions entered in the output conditions entry page to the computer 22 of the user 20 via the Internet 10. In the case of selection of the delivery supply method, that is, in response to a click of the ‘Deliver’ button in the example of FIG. 10, on the other hand, the reception server 132 transmits the ID assigned to the content selected in the content selection page, the content output conditions entered in the output conditions entry page, and the personal information of the user 20 to the server in the center corresponding to the content type. In the example of the still image, the ID and the output conditions of the selected image and the personal information of the user 20 are transmitted to the printing server 142 in the print center 140 via the network 138.

The computer 22 of the user 20 receives the distributed content data and causes the content data to be output according to the entry of the content output conditions with a peripheral device (the printer 24 in the case of the still image) connecting with the computer 22. The output of the content data with the peripheral device is controlled by the control signal, which has been distributed together with the content data from the reception server 132 to the computer 22. The number of outputs is also under control.

The server in each center receives the ID and the output conditions of the content and the personal information of the user 20, and causes the content specified by the ID to be processed according to the content output conditions and output with the corresponding processing machine. A resulting content processed matter obtained by processing the content is then delivered from the center to the user 20, based on the personal information of the user 20. In the example of the still image, in the similar manner to the first embodiment, the image data specified by the ID is processed according to the image output conditions (printing conditions), is printed with the large-sized printer 144, and is delivered to the user 20.

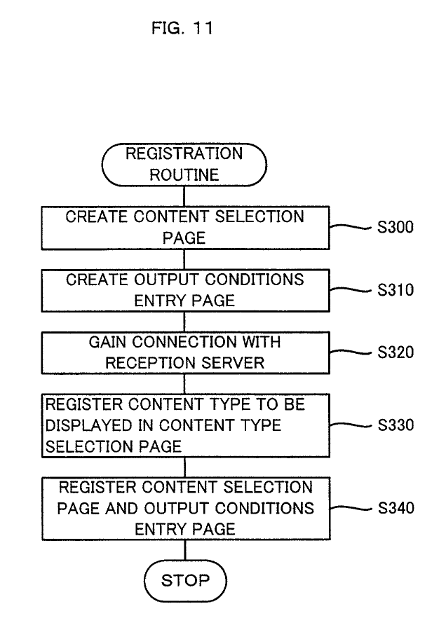

The following describes registration of the processing conditions and available contents by the processing server. FIG. 11 is a flowchart showing a registration routine executed by the processing server. When the program enters the registration routine, the processing server first creates a content selection page (step S300). The content selection page is varied according to the content type, and is created as a Web page that displays multiple contents in a hierarchical manner or over multiple pages as available options. In the example of the still image content, the content selection page may be the image selection page shown in FIG. 3. The processing server then creates an output conditions entry page (step S310). The output conditions entry page is also varied according to the content type, and is created as a Web page that displays multiple sets of content processing conditions as selectable options. In the example of the still image content, the output conditions entry page may be the input dialog box for the print size shown in FIG. 4.

After creation of the content selection page and the output conditions entry page, the processing server gains connection with the reception server 132 (step S320) and registers the content type to be displayed as an option in the content type selection page required by the reception server 132 (step S330). The processing server subsequently registers the content selection page and the output conditions entry page mapped to the registered content type (step S340), and exits from this registration routine. Registration of the content type and the pages follow the processing of creating homepages on the Internet. When the user 20 gains access to the contents supply site after the registration, all the registered content types are displayed as available options in the content type selection page (see FIG. 9). In response to the user s selection of the desired content type, the content selection page and the output conditions entry page registered in mapping to the content type open to enable the user to select a desired content and enter the output conditions. In the case of selection of the delivery supply method, the ID and the output conditions of the selected content and the personal information of the user 20 are transmitted to the processing server, in which the selected content type is registered.

In the contents supply system 130 of the second embodiment described above, connection of the reception server 132 with each processing server enables a single contents supply site to accept multiple different types of contents, make a selected content subjected to processing required by the user 20, and supply the processed content to the user 20. The user 20 can select the content supply method between the distribution supply method that receives distribution of the selected content and outputs the content with a peripheral device connected to the computer 22 of the user and the delivery supply method that delivers a content processed matter obtained by processing the selected content with the corresponding processing machine in the center. The user 20 can thus output the selected content with the peripheral device connected to the own computer 22 or alternatively receive delivery of the content processed matter obtained by processing and outputting the content according to the output conditions, which are not applicable to the own peripheral device because of its restricted performances.

In the contents supply system 130 of the second embodiment, the processing server that can supply a new type of contents makes registration on the reception server 132 to allow supply of the contents to the user 20 via the Internet 10. The reception server 132 then accepts requirements of supply of this new type of contents.

In the contents supply system 130 of the second embodiment, the contents are those distributable from the reception server 132 to the computer 22 of the user 20 via the Internet 10. The contents may, however, be those indistributable from the reception server 132 to the computer 22 of the user 20 via the Internet 10. In the latter case, the delivery supply method that delivers a content processed matter from the center is the only option as the content supply method.

In the contents supply system 130 of the second embodiment, the reception server 132 is connected to the printing server 142 and the CD processing server 152 via the network 138 different from the Internet 10. The reception server 132 may, however, be connected to the printing server 142 and the CD processing server 152 via the Internet 10. In the latter case, the printing server 142 or the CD processing server 152 may directly receive a request of content supply from the user 20. Namely the printing server 142 may be used as a Web server providing a still image supply site that supplies still images to the user 20 via the Internet 10. The CD processing server 152 may be used as a Web server providing a music supply site that supplies pieces of music to the user 20 via the Internet 10.

In the contents supply system 130 of the second embodiment, a desired content supply method i s selectable between the two options, that is, the distribution supply method that distributes the content data and the delivery supply method that delivers a resulting content processed matter. One possible modification allows selection of one content supply method among three or more options.

In the contents supply system 130 of the second embodiment, the reception server 132 is constructed by one computer, although the reception server 132 may be constructed by a plurality of computers.

In the contents supply system 130 of the second embodiment, the reception server 132 has the hard disk drive as the external storage device and distributes the content data stored in the hard disk to the computer 22 of the user 20. The hard disk drive may be replaced with a removable disk drive for a removable disk, such as a flexible disk, a magneto-optic disc (MO), a compact disc (CD), a digital video disc (DVD), a PC card (trademark by Personal Computer Memory Card International Organization), or a flash memory card. The content data is then read from the removable disk inserted in the removable disk drive and is distributed.

In the content supply system 130 of the second embodiment, the printing server 142 or the CD processing server 152 has the hard disk drive as the external storage device, and prints or processes the still image data or the music data stored in the hard disk with the large-sized printer 144 or the CD processing machine 154. The hard disk drive may be replaced with any of the removable disk drives mentioned above. The still image data or the music data is then read from the removable disk inserted in the removable disk drive and is printed or processed with the large-sized printer 144 or the CD processing machine 154. The large-sized printer 144 or the CD processing machine 154 may be provided with the removable disk drive, instead of the printing server 142 or the CD processing server 152. In this case, the printing server 142 or the CD processing server 152 transmits the ID of the desired content data to the large-sized printer 144 or the CD processing machine 154.

The above embodiments and their modified examples are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. A contents supply system that supplies contents to users via a network, said contents supply system comprising:
a content selection module that selects a content in response to a choice of each user;
a supply method setting module that selects and specifies a content supply method among at least two different content supply methods, in response to a choice of the user; and
a content supply instruction module that supplies the selected content to the user or gives an instruction for the supply according to the specified supply method.

2. A contents supply system in accordance with claim 1, wherein said supply method setting module selects and specifies a content supply method among a plurality of available supply methods including a distribution supply method, which distributes the selected content via the network, and a delivery supply method, which delivers a content processed matter obtained by processing of the selected content.

3. A contents supply system in accordance with claim 2, wherein said content supply instruction module distributes the selected content to the user via the network in response to selection of the distribution supply method by said supply method setting module, while transmitting information regarding delivery to the user and information regarding the processing of the selected content as the supply instruction in response to selection of the delivery supply method by said supply method setting module.

4. A contents supply system in accordance with claim 2, wherein the content is digital data, such as image data, sound data, character data, or a computer software, and
the content processed matter is a content storage medium, in which the content is stored according to a preset format.

5. A contents supply system in accordance with claim 2, wherein the content is either of image data and character data, and
the content processed matter is a printed matter obtained by printing the content.

6. A server for a contents supply site that is capable of supplying contents to users via a network, said server comprising:
a content selection page providing module that provides a content selection page to allow each user to select a desired content; and
a supply method selection page providing module that provides a supply method selection page to allow the user to select a desired supply method for the content selected in the content selection page.

7. A server in accordance with claim 6, said server further comprising:
a supply method check page providing module that provides a supply method check page to check supply of the selected content to the user according to the supply method selected in the supply method selection page.

8. A server in accordance with claim 6, wherein the supply method selection page shows, as available options, multiple supply methods including a distribution supply method, which distributes the selected content via the network, and a delivery supply method, which delivers a content processed matter obtained by processing the selected content.

9. A server in accordance with claim 8, wherein the content is digital data, such as image data, sound data, character data, or a computer software, and
the content processed matter is a content storage medium, in which the content is stored according to a preset format.

10. A server in accordance with claim 8, wherein the content is either of image data and character data, and
the content processed matter is a printed matter obtained by printing the content.

11. A contents supply system comprising a reception server that accepts requests of supply of contents to users via a network and at least one processing machine corresponding to each content type communicably connected to said reception server,
wherein said reception server comprises: a reception module that accepts each request of supply with a user's selection of a desired content and a desired supply method of the selected content; and a supply request transfer module that transfers the accepted request of supply to a processing machine corresponding to a content type involved in the request of supply, according to the selected supply method involved in the request of supply,
said processing machine comprising: a processing module that makes the content, which is involved in the request of supply transferred by said supply request transfer module, subjected to processing corresponding to the selected supply method involved in the request of supply; and an instruction output module that gives an instruction to attain delivery of a content processed matter, which is obtained by processing t h e selected content, to the user involved in the request of supply.

12. A contents supply system in accordance with claim 11, wherein said processing machine comprises a processing information transmission module that transmits processing information regarding available processing by said processing module to said reception server, and
said reception module of said reception server displays available supply methods to allow selection of the user, based on the processing information transmitted by said processing information transmission module.

13. A contents supply system in accordance with claim 11, wherein the available supply methods include a distribution supply method, which distributes the selected content via the network, and a delivery supply method, which delivers a content processed matter, and
said reception server distributes the content involved in the request of supply to the user involved in the request of supply via the network, when the supply method involved in the request of supply is the distribution supply method.

14. A contents supply system in accordance with claim 11, wherein the content is any of image data, sound data, character data, and computer software, and
the content processed matter is a content storage medium, in which the content is stored according to a preset format.

15. A contents supply system in accordance with claim 1, wherein the content is either of image data and character data, and
the content processed matter is a printed matter obtained by printing the content.

16. A contents supply system in accordance with claim 11, wherein said processing machine is connected to said reception server via the network.

17. A reception server that accepts requests of supply of contents to users via a network in a contents supply system comprising said reception server and at least one processing machine corresponding to each content type communicably connected to said reception server, said reception server comprising:
a reception module that accepts each request of supply of a content to a user with the user's selection of a desired content and a desired supply method of the selected content; and
a supply request transfer module that transfers the accepted request of supply to a processing machine corresponding to a content type involved in the request of supply, according to the selected supply method involved in the request of supply.

18. A reception server in accordance with claim 17, wherein said reception module displays a supply method corresponding to available processing by said processing machine to allow selection of the user, and receives the request of supply from the user.
